(19) United States
(12) Patent Application Publication
(10) Pub. No.: US 2023/0196439 A1
(43) Pub. Date: Jun. 22, 2023

(54) SYSTEM FOR DYNAMICALLY GENERATING RECOMMENDATIONS TO PURCHASE SUSTAINABLE ITEMS

(71) Applicant: Starbucks Corporation, Seattle, WA (US)

(72) Inventor: Brian Shaw Ames, North Bend, WA (US)

(21) Appl. No.: 18/065,203

(22) Filed: Dec. 13, 2022

Related U.S. Application Data
(60) Provisional application No. 63/265,760, filed on Dec. 20, 2021.

(51) Int. Cl. G06Q 30/0601

(52) U.S. Cl. CPC G06Q 30/0631

(57) ABSTRACT

The disclosure generally relates to a system for generating recommendations for a user. The system may obtain account data associated with a user. Based on the account data associated with the user, the system may access a machine learning model to determine a propensity for conversion to sustainability. The propensity for conversion to sustainability may be based on one or more purchases by the user of one or more sustainable items. Further, the propensity for conversion to sustainability may be based on one or more purchases by one or more similar users of one or more sustainable items. The system can generate recommendations for the user and the recommendations may include at least one recommendation for a sustainable item based on the propensity for conversion to sustainability.

### RELATED APPLICATIONS

This application claims priority under 35 U.S.C. § 119(e) to U.S. Provisional Patent Application No. 63/265,760, filed Dec. 20, 2021 and entitled “SYSTEM FOR DYNAMICALLY GENERATING RECOMMENDATIONS TO PURCHASE SUSTAINABLE ITEMS,” which is incorporated herein by reference in its entirety.

### FIELD

The present disclosure generally relates to a system for generating recommendations to purchase sustainable items (e.g., carbon negative items or carbon neutral items).

### BACKGROUND

Food and beverages can be created by adding or mixing different quantities of ingredients (e.g., bases, flavors, add-ons, etc.). For example, food and beverages may include burgers, coffees, teas, etc. that are created by mixing the different ingredients together. Based on the ingredients that are used to create the particular food and beverages, particular items may be classified as sustainable or non-sustainable.

Recommendations for food and beverages are currently generated for users as shown in FIG. 2A. For example, a plurality of recommendations are generated for a particular user and displayed on a user computing device of the user. Each of the plurality of recommendations may include a recommendation for a particular item based on a previous purchase by the user of the item.

### BRIEF DESCRIPTION OF THE DRAWINGS

FIG. 1 is a block diagram depicting an illustrative environment in which a recommendation computing system can generate a plurality of recommendations for a user.

FIGS. 2A, 2B, 2C, and 2D are embodiments of pictorial diagrams depicting example user interfaces generated by the recommendation computing system.

FIGS. 3A and 3B are flow diagrams depicting example interactions for generating the plurality of recommendations.

FIG. 4 is a flow chart depicting an illustrative routine for generating the plurality of recommendations.

FIGS. 5A and 5B are flow diagrams depicting example interactions for assigning a sustainability score to an entity and implementing one or more tasks to increase the value of the entity using the sustainability score.

FIG. 6 depicts a general architecture of a computing device providing the recommendation computing system that is configured to generate the plurality of recommendations for a user.

Various embodiments are depicted in the accompanying drawings for illustrative purposes and should in no way be interpreted as limiting the scope of the embodiments. Furthermore, various features of different disclosed embodiments can be combined to form additional embodiments, which are part of this disclosure.

### DESCRIPTION OF SOME EMBODIMENTS

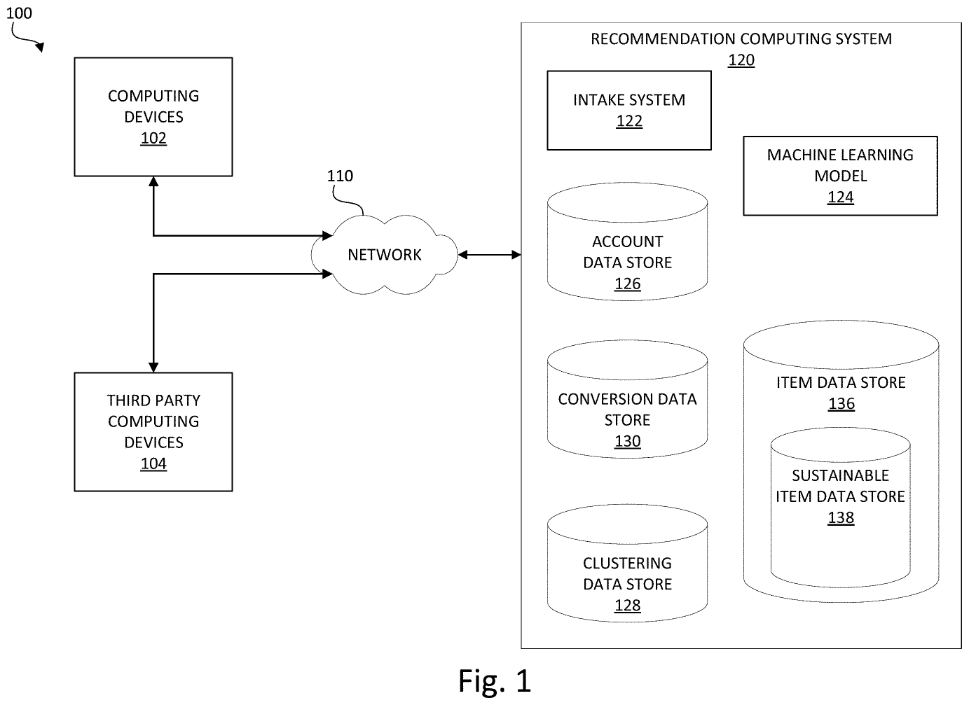

FIG. 1 is a block diagram of an illustrative operating environment 100 in which computing devices 102 (e.g., computing devices associated with a user, computing devices associated with a store, etc.) and third party computing devices 104 (e.g., computing devices that may not be associated with a particular user or may be associated with a group of users) may interact with a recommendation computing system 120 via a network 110. By way of illustration, various types of computing devices 102 may be in communication with the recommendation computing system 120 (the recommendation system), including a desktop computer, laptop, and a mobile phone. In general, the computing devices 102 can be any computing device such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like. The recommendation computing system 120 may provide the computing devices 102 with one or more user interfaces, command-line interfaces (CLI), application programing interfaces (API), and/or other interfaces for displaying one or more recommendations (e.g., as part of a computer display). Although one or more embodiments may be described herein as using a user interface, it should be appreciated that such embodiments may, additionally or alternatively, use any CLIs, APIs, or other interfaces. By way of further illustration, various example third party computing devices 104 are shown in communication with the recommendation computing system 120, including an electronic display, a billboard, a television monitor, or any other computing device. In general, the third party computing devices 104 may be any computing device and the recommendation computing system 120 may provide the third party computing devices 104 with one or more recommendations for display for a user. Further, the third party computing devices 104 may include any computing devices to receive information identifying a purchase of an item by a user. For example, the third party computing devices 104 may include a cash register computing system that identifies purchases of particular items by a particular user. Therefore, the user may purchase an item via the third party computing devices 104.

### Network

The computing devices 102, the third party computing devices 104, and the recommendation computing system 120 may communicate via a network 110, which may include any wired network, wireless network, or combination thereof. For example, the network 110 may be a personal area network, local area network, wide area network, over-the-air broadcast network (e.g., for radio or television), cable network, satellite network, cellular telephone network, or combination thereof. As a further example, the network 110 may be a publicly accessible network of linked networks, possibly operated by various distinct parties, such as the Internet. In some embodiments, the network 110 may be a private or semi-private network, such as a corporate or university intranet. The network 110 may include one or more wireless networks, such as a Global System for Mobile Communications (GSM) network, a Code Division Multiple Access (CDMA) network, a Long Term Evolution (LTE) network, or any other type of wireless network. The network 110 can use protocols and components for communicating via the Internet or any of the other aforementioned types of networks. For example, the protocols used by the network 110 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

### Recommendation Computing System

The recommendation computing system 120 may be implemented directly in hardware or software executed by hardware devices and may, for instance, include one or more physical or virtual servers implemented on physical computer hardware configured to execute computer executable instructions for performing various features that will be described herein.

In the example of FIG. 1, the recommendation computing system 120 is illustrated as connected to the network 110. In some embodiments, any of the components within the recommendation computing system 120 can communicate with other components of the recommendation computing system 120 via the network 110. In other embodiments, not all components of the recommendation computing system 120 are capable of communicating with other components of the environment 100. In one example, only the intake system 122 may be connected to the network 110, and other components of the recommendation computing system 120 may communicate with other components of the environment 100 via the intake system 122.

In FIG. 1, the computing devices 102 and/or the third party computing devices 104, may interact with the recommendation computing system 120. In some embodiments, the computing devices 102 may be user computing devices to enable a user to perform one or more operations. For example, the users may be customers and the customers may establish an account and purchase one or more items via the account. The customers may register an account via the computing devices 102 and/or the third party computing devices 104. Further, the user can use the account to purchase one or more items. For example, the account may be associated with particular account data (e.g., an account identifier, payment information, location information, billing information, purchase history, sustainable item purchase history, etc.). Based on the account associated with the user, the user can purchase one or more items via an item purchase computing system.

In other embodiments, the computing devices 102 may be associated with an account of an organization, a store, a shop, etc. Each store in a group of stores may be associated with a particular account to provide data associated with the store. For example, the computing devices 102 may be associated with a particular store account and a user may provide account data (e.g., store account data) indicating information associated with the store. For example, the account data associated with the store may indicate items available for purchase, sustainable items available for purchase, sales, revenue, sales of sustainable items, sales of non-sustainable items, etc.

The computing devices 102 and/or the third party computing devices 104, may provide various item information, sale information, and/or purchase information as account data to the item purchase computing system and to the recommendation computing system 120. Therefore, the account data may identify a plurality of previous item purchases, item sales, etc. associated with a particular account (e.g., item purchases by a particular user and/or item sales by a particular store).

### Intake System

To enable the generation of item recommendations for the user and/or the store, the recommendation computing system 120 includes an intake system 122, which can enable interaction with the computing devices 102 and/or the third party computing devices 104. In an illustrative embodiment, the intake system 122 intake information from computing devices, enabling users (via computing devices 102 and/or third party computing devices 104) to generate information and provide the information to the recommendation computing system. The intake system 122 includes a variety of components to enable interaction between the recommendation computing system 120 and the other computing devices. For example, the intake system 122 may include a display system (e.g., a user interface) that causes display of information via the computing devices 102 and/or the third party computing devices 104 providing the ability for the user, via the computing devices 102 and/or the third party computing devices 104, to purchase particular items. In one embodiment, the display may be displayed by an additional computing system.

### Account Data Store

Based on receiving the account data (e.g., information identifying a plurality of previous item purchases by a user, information identifying a plurality of previous item sales by a store), the recommendation computing system 120 may store the account data. The recommendation computing system 120 may include an account data store 126. The recommendation computing system 120 may store the account data (e.g., account data identifying the plurality of previous item purchases by the user. account data identifying the plurality of previous item sales by the store, etc.) in the account data store 126. In some embodiments, the recommendation computing system 120 may obtain the account data from a third party computing system. For example, the third party computing system may monitor a particular user, determine a plurality of previous purchases by the user, and provide account data identifying the plurality of previous purchases by the user to the recommendation computing system. Further, the recommendation computing system 120 may store additional account data in the account data store 126. The additional account data may include additional data about the account, the store, and/or the user. For example, the additional account data may include additional data identifying the account, the user, etc. (e.g., a location associated with the account, a telephone number associated with the account, etc.). Further, the additional account data may include data determined from the account data. For example, the additional account data may include data identifying frequent purchases of the user, infrequent purchases of the user, favorite purchases of the user, the average time between purchases, the average time and/or day of purchases, and/or other data determined from the plurality of previous purchases by the user. The additional account data may include data determined by the recommendation computing system 120 from the account data. In some embodiments, the additional account data may include data obtained by a third party computing system.

### Item Data Stores

The recommendation computing system 120 may include an item data store 136. The item data store 136 may identify one or more items that are available, were previously available, or will be available for purchase by the user. The item data store 136 may further include a sustainable item data store 138 that identifies one or more sustainable items of the one or more items. In some embodiments, the item data store 136 and the sustainable item data store 138 may be separate item data stores. For example, the item data store 136 may be a non-sustainable item data store. Therefore, the one or more items may include one or more non-sustainable items and one or more sustainable items. The one or more non-sustainable items may include one or more environmentally negative food items (e.g., carbon positive food items) and one or more environmentally neutral or environmentally positive food items (e.g., carbon neutral or carbon positive food items). For example, the one or more non-sustainable items may include items that have a negative impact on the environment (e.g., are non-sustainable) and the one or more sustainable items may include items that have a positive or neutral impact on the environment (e.g., are sustainable). By identifying one or more non-sustainable items and one or more sustainable items, the recommendation computing system 120 may dynamically monitor and identify particular items. In some embodiments, the recommendation computing system 120 may classify items as sustainable or non-sustainable (e.g., based on sustainability criteria). In other embodiments, the recommendation computing system 120 may receive input from another computing system (e.g., an item classifier) classifying items as sustainable items or non-sustainable items. Each of the one or more items may be associated with sustainability rankings. For example, items that are more sustainable (e.g., a plant based burger, a cappuccino with almond milk, a plant based chicken nugget) may have a higher sustainability ranking than items that are less sustainable (e.g., a turkey burger, a milkshake with almond milk and cow's milk, etc.)

### Clustering Data Store

The recommendation computing system may store clustering data in a clustering data store 128. Based on the stored account data, the recommendation computing system 120 may identify one or more clusters of users or stores that are associated with the particular user or store. Each of the one or more clusters of users or stores may include users that share particular characteristics or features. For example, a particular cluster of the one or more clusters of users may include users or stores that share the same or similar location characteristics, purchasing characteristics (e.g., type of sale characteristics, size or frequency of sale characteristics, type of purchase characteristics, size of purchase characteristics, frequency of purchase characteristics, or any other characteristics associated with a purchase or sale), demographic characteristics, familial characteristics, or any other characteristics associated with the user or the store. Each user or store may correspond to one or more particular clusters of users or stores based on the account data associated with the user or store. The clusters of users or stores associated with a particular user or store may be updated (e.g., periodically or aperiodically).

The recommendation computing system 120 may identify one or more clusters of users or stores that correspond to the user or store. For example, the recommendation computing system 120 may parse the account data to identify particular characteristics of the user or store and may identify one or more clusters of users or store who share one or more of the particular characteristics of the user or store. The recommendation computing system 120 may identify the one or more clusters of users or stores and generate clustering data identifying the one or more clusters of users or stores. Further, the recommendation computing system may store the clustering data in a clustering data store 128. For example, the recommendation computing system may store the clustering data with at least a portion of the account data to identify the user, the store, and/or account (e.g., an account identifier).

### Machine Learning Model: Sustainability Score Prediction

In order to determine a likelihood that a user will convert to purchasing sustainable items and/or a likelihood that a store will convert to selling sustainable items, the recommendation computing system 120 includes a machine learning model 124 (e.g., a neural network). The machine learning model 124 may receive input from at least the account data store 126 and the clustering data store 128 identifying information associated with a particular user or store. For example, the machine learning model 124 may receive as input the plurality of previous item purchases by the user, the type of purchases by the user (e.g., sustainable or non-sustainable), the one or more clusters of users that have been mapped to the user, etc. The machine learning model 124, based on the received input, may dynamically determine a propensity for conversion to sustainability for the user or store, which can be represented by a sustainability score. For example, the propensity for conversion to sustainability for the user may be a predicted propensity for the user to be open to purchasing one or more sustainable items. Further, the propensity for conversion to sustainability for the store may be a predicted propensity for the store to be open to selling one or more sustainable items. The propensity for conversion to sustainability for the user or store may be based on prior activity associated with the user or store (e.g., one or more prior purchases of the user of sustainable items or items with a higher sustainability or activity of similar users such as users of the one or more clusters of users associated with the user). Therefore, the machine learning model 124 can predict a propensity for conversion to sustainability for the user and/or the store. It will be understood that the machine learning model 124 can use any forecasting or predicting algorithm to predict a probability or propensity that the user or the store will be open to conversion to purchasing or selling sustainable items. In some embodiments, the machine learning model 124 may determine a sustainability score for a particular worker at a particular store. For example, the sustainability score for the particular worker may identify a probability that the particular worker will be open to selling sustainable items.

### Conversion Data Store

The recommendation computing system 120 may include a conversion data store 130 and may store the sustainability score in the conversion data store 130 as conversion data. Based on identifying the propensity for conversion to sustainability for the user or the store, the recommendation computing system 120 may store the propensity for conversion to sustainability, which can be represented as a sustainability score, for the user or the store. Further, the recommendation computing system 120 may store the sustainability score in association with an account identifier identifying the account of the user or the store. In some embodiments, the recommendation computing system 120 may obtain the sustainability score from a third party computing system. For example, the third party computing system may separately determine sustainability score and provide the sustainability score to the recommendation computing system 120.

### Machine Learning Model: Recommendation Generation

The machine learning model 124 may generate one or more recommendations for the user or the store based on the predicted propensity for conversion to sustainability for the user or the store. The machine learning model 124 may predict the propensity for conversion to sustainability and generate the one or more recommendations for the user or the store. In some embodiments, the machine learning model 124 may include a first machine learning model to predict the propensity for conversion to sustainability for the user or the store and a second machine learning model to generate the recommendations. For example, the machine learning model 124 may include a first machine learning model (e.g., a recommendation generator) trained to identify one or more recommendations for a user or a store based at least in part on the sustainability score for the user or the store. The machine learning model 124 may receive the sustainability score for the user or the store as an input from the conversion data store 130, the item data from the item data store 136, and the sustainable item data from the sustainable item data store 138. In some embodiments, the machine learning model 124 may also obtain one or more of account data from the account data store 126 or clustering data from the clustering data store 128. Therefore, the machine learning model 124 may generate one or more recommendations to purchase or sell (or offer for sale) one or more items as identified by the item data and/or one or more sustainable items as identified by the sustainable item data for the user or the store based on the sustainability score.

In traditional recommendation computing systems, the recommendation computing system may generate recommendations for a user based on previous purchases of the user. For example, if the user has previous purchased particular items (e.g., items #1 and #2), the recommendation computing system may generate a recommendation for the user to purchase these items again. The recommendation may be based on the user's prior purchase of the items. However, by generating recommendations based on the prior purchases of the user, the recommendations by the recommendation computing system may not be based on a propensity for conversion by the user (e.g., the propensity for conversion to sustainability for the user). Instead, traditional recommendation computing systems may recommend that users purchase the same non-sustainable items that a user has previously purchased. By generating recommendations based on the previous item purchases, the recommendations may not capture a user's propensity for conversion to different types of products. Further, this can lead to never recommending that users select sustainable items.

By generating the recommendation based on the propensity for conversion to sustainability, the recommendation computing system 120 addresses these problems. The machine learning model 124 can generate one or more recommendations for the user or the store based on the propensity for conversion to sustainability for the user or the store. The one or more recommendations may include recommendations to purchase or sell sustainable items and recommendations to purchase non-sustainable items. The ratio between the recommendations to purchase sustainable items and the recommendations to purchase or sell non-sustainable items may be based on the determined propensity for conversion to sustainability for the user. For example, users or stores with a higher propensity for conversion to sustainability may be recommended a greater number of sustainable items while users or stores with a lower propensity for conversion to sustainability may be recommended no or a lower number of sustainable items. Therefore, the recommendation computing system 120 can proactively and dynamically determine how a user or store is likely to respond to a recommendation to purchase a sustainable item and tailor the recommendations for the user accordingly.

Based on the recommendations generated for the user or store by the machine learning model 124, the recommendation computing system 120 can cause display of the recommendations. The recommendation computing system 120 can cause display of the recommendations via the computing devices 102 and/or the third party computing devices 104. For example, the recommendation computing system 120 can cause display of the recommendations via an API, a CLI, or any other interface associated with the computing devices 102 and/or the third party computing devices 104. The recommendation computing system 120 may cause display of the recommendations based on determining that the user or a worker associated with the store is accessing and/or within a particular distance of a particular device or a particular interface. For example, based on determining that a user or worker is interacting with a particular third party computing device 104, the recommendation computing system 120 may cause display of a recommendation of the one or more recommendations.

It will be understood that many of the components described in FIG. 1 are optional, and that embodiments of the present disclosure may combine or reorganize the components. Further, embodiments of the present disclosure may include less, different, or more components. Furthermore, the components need not be distinct or discrete. For example, the recommendation computing system 120 may be represented in a single physical device, or, alternately, may be split into multiple physical devices.

### Example Recommendation User Interfaces

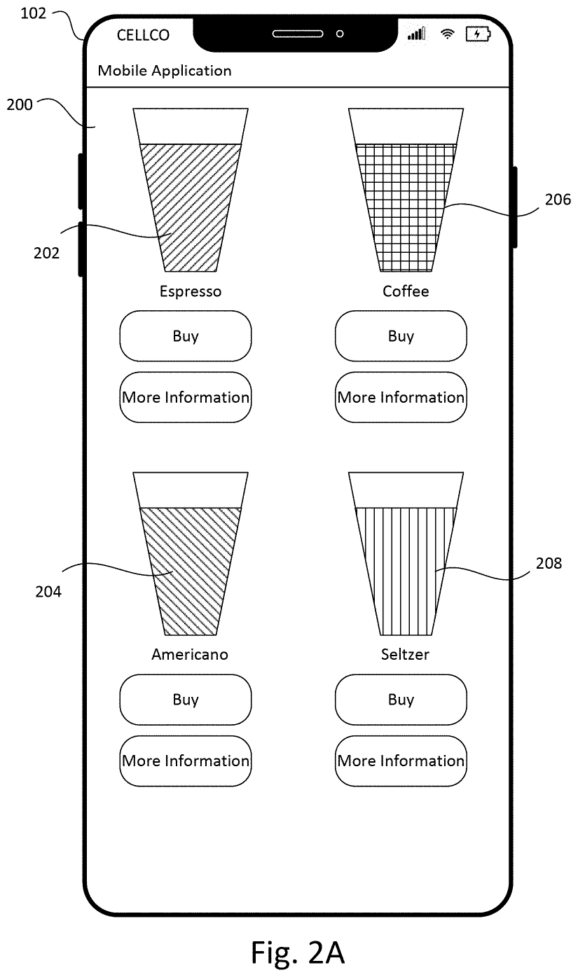

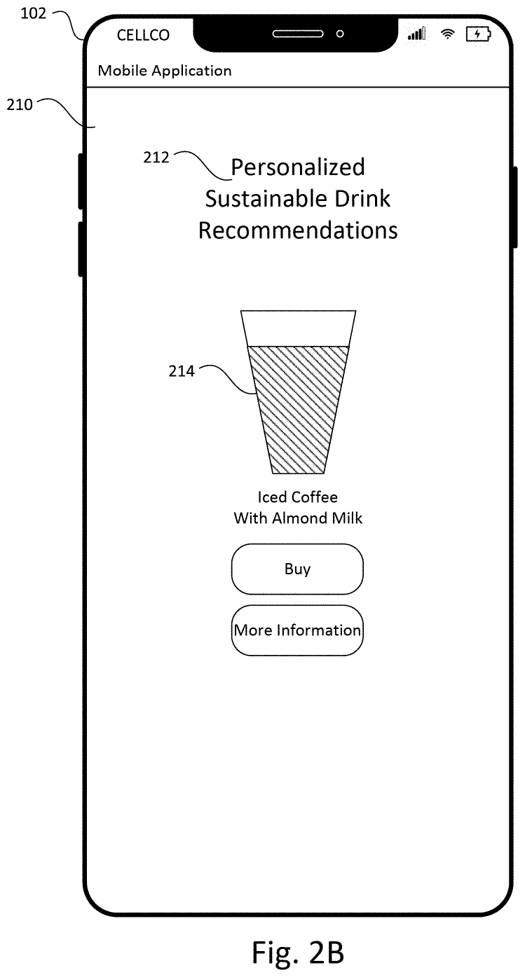

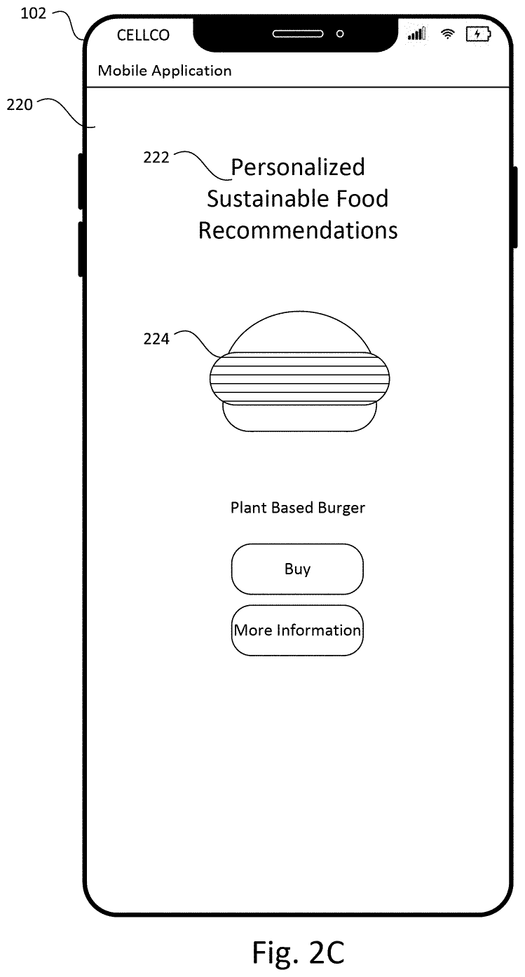

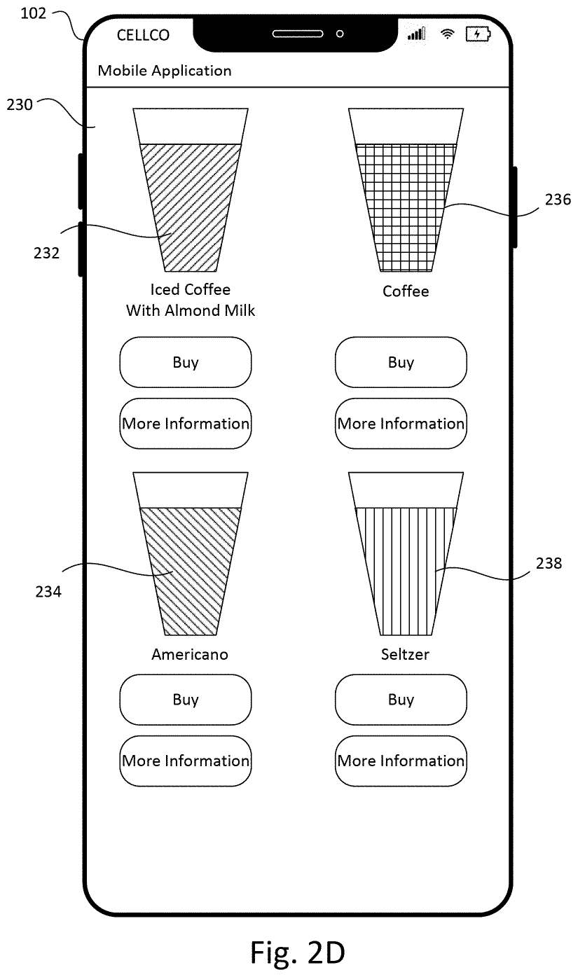

FIG. 2A is a pictorial diagram depicting an example user interface 200 by which a mobile computing device 102 may provide recommendations. The recommendations may be generated by the recommendation computing system 120 of FIG. 1 and the recommendation computing system 120 may provide (or cause display of) the recommendations based on receiving a prompt from the computing device 102 or identifying an action associated with the computing device 102 (e.g., navigation to a particular API).

In the user interface 200, the recommendations include recommendations to purchase a plurality of drink items. In some embodiments, the user interface 200 may identify a plurality of items responsive to a prompt by the user and a plurality of items based on the recommendations. For example, the user interface 200 may include a plurality of items responsive to a search request by a user (e.g., a search for “iced coffee”) and, in displaying the results of the search request, the user interface 200 may also display a plurality of items based on recommendations particular to the user. In some embodiments, each of the items corresponding to a recommendation may be associated with a recommendation identifier. For example, each item recommended by the recommendation computing system 120 may include an identifying line of text (e.g., “a recommendation”).

In the example of FIG. 2A, the recommendations include a first recommendation 202, a second recommendation 204, a third recommendation 206, and a fourth recommendation 208. Each of the recommendations may include a recommendation for a particular food item and/or a particular drink item (e.g., a beverage). The first recommendation 202 may include a recommendation for an espresso, the second recommendation 204 may include a recommendation for an americano, the third recommendation 206 may include a recommendation for a coffee, and the fourth recommendation 208 may include a recommendation for a seltzer. It will be understood that the recommendations may include more, less, or different recommendations.

Each of the recommendations may be associated with particular inputs. For example, each of the recommendations includes an input to buy the item associated with the recommendation. Further, each of the recommendations include an input to receive more information about the particular item. The user, via the computing device 102 of FIG. 1, may be able to interact with each of the inputs (e.g., to place an order or buy a particular item). It will be understood that each of the recommendations may be associated with more, less, or different inputs.

In the example of FIG. 2A, each of the recommendations may be associated with non-sustainable items. For example, the recommendation computing system 120 may determine the associated user has a low propensity for conversion to sustainability (as represented by a low sustainability score) and generate recommendations for non-sustainable items based on the determined low propensity for conversion to sustainability. Further, each of the items associated with the recommendations may include non-sustainable ingredients or elements. For example, the first recommendation 202 may include a recommendation for an espresso with cow's milk, the second recommendation 204 may include a recommendation for an americano with cow's milk, the third recommendation may include a recommendation for a coffee with cow's milk, and the fourth recommendation may include a recommendation for a seltzer packaged in a plastic housing (while the seltzer may be sustainable, the plastic housing may result in the item being classified as non-sustainable and/or having a low sustainability ranking).

FIG. 2B is a pictorial diagram depicting an example user interface 210 by which a mobile computing device 102 may provide recommendations. The recommendations may be generated by the recommendation computing system 120 of FIG. 1 and the recommendation computing system 120 may provide (or cause display of) the recommendations based on receiving a prompt from the computing device 102 or identifying an action associated with the computing device 102 (e.g., navigation to a particular API).

In the user interface 210, the recommendations include a recommendation to purchase a particular drink item. In the example of FIG. 2B, the recommendation includes a recommendation 214 for an iced coffee with almond milk. It will be understood that the recommendations may include more, less, or different recommendations.

The recommendation computing system 120 may generate the recommendation 214 based on a determined propensity for conversion to sustainability for the associated user. For example, the recommendation computing system 120 may determine the user has a high propensity for conversion to sustainability (e.g., a propensity for conversion to sustainability that is higher than a particular threshold). Based on this determination, the recommendation computing system 120 may generate the recommendations for the user and the recommendations may include at least the recommendation 214.

The user interface 210 may further cause display of text 212 (e.g., a prompt) or otherwise display information identifying the item is a sustainable item. For example, the user interface 210 may identify the item as a sustainable item and prompt (encourage) the user to purchase the item based on the propensity for conversion to sustainability. The recommendation computing system may generate the text 212 (e.g., in a text box) and/or other information for display. In some embodiments, the display for the user may be based on information associated with the user. For example, the recommendation computing system may determine that the user is likely to respond better to information about the general state of the environment, the positive impact of choosing a sustainable item, the negative impact of choosing a non-sustainable item, the impact of previous purchases by the user, or any other information associated with sustainability. In the example of FIG. 2B, the text 212 includes a prompt “Personalized Sustainable Drink Recommendations.” It will be understood that the text 212 may include more, less, or different information. In some embodiments, the recommendation may not include an indication that the recommended item is classified as a sustainable item.

FIG. 2C is a pictorial diagram depicting an example user interface 220 by which a mobile computing device 102 may provide recommendations. The recommendations may be generated by the recommendation computing system 120 of FIG. 1 and the recommendation computing system 120 may provide (or cause display of) the recommendations based on receiving a prompt from the computing device 102 or identifying an action associated with the computing device 102 (e.g., navigation to a particular API).

In the user interface 220, the recommendations include a recommendation to purchase a particular food item. In the example of FIG. 2C, the recommendation includes a recommendation 224 for a plant based burger. It will be understood that the recommendations may include more, less, or different recommendations.

The recommendation computing system 120 may generate the recommendation 224 based on a determined propensity for conversion to sustainability for the associated user. For example, the recommendation computing system 120 may determine the user has a high propensity for conversion to sustainability (e.g., a propensity for conversion to sustainability that is higher than a particular threshold). Based on this determination, the recommendation computing system 120 may generate the recommendations for the user and the recommendations may include at least the recommendation 224. In some embodiments, the recommendation computing system 120 may determine a propensity for conversion to sustainability for food items for the users and a propensity for conversion to sustainability for drink items for the users. For example, the recommendation computing system 120 may determine that a user may be more likely to purchase a sustainable food item in response to a recommendation than to purchase a sustainable drink item in response to a recommendation. In other embodiments, the recommendation computing system 120 may determine a singular propensity for conversion to sustainability for the user.

The user interface 220 may further cause display of text 222 (e.g., a prompt) or otherwise display information identifying the item is a sustainable item. For example, the user interface 220 may identify the item as a sustainable item and prompt (encourage) the user to purchase the item based on the propensity for conversion to sustainability. In the example of FIG. 2C, the text 222 includes a prompt “Personalized Sustainable Food Recommendations.” It will be understood that the text 222 may include more, less, or different information.

FIG. 2D is a pictorial diagram depicting an example user interface 230 by which a mobile computing device 102 may provide recommendations. The recommendations may be generated by the recommendation computing system 120 of FIG. 1 and the recommendation computing system 120 may provide (or cause display of) the recommendations based on receiving a prompt from the computing device 102 or identifying an action associated with the computing device 102 (e.g., navigation to a particular API). The example user interface 230 may be similar to the example user interface 200 of FIG. 2A, however, the example user interface 230 may include a recommendation for at least one sustainable item.

In the user interface 200, the recommendations include recommendations to purchase a plurality of drink items. In the example of FIG. 2D, the recommendations include a first recommendation 232, a second recommendation 234, a third recommendation 236, and a fourth recommendation 238. Each of the recommendations may include a recommendation for a particular food item and/or a particular drink item (e.g., a beverage). The first recommendation 232 may include a recommendation for an iced coffee with almond milk, the second recommendation 234 may include a recommendation for an americano, the third recommendation 236 may include a recommendation for a coffee, and the fourth recommendation 238 may include a recommendation for a seltzer. It will be understood that the recommendations may include more, less, or different recommendations.

In the example of FIG. 2D, the first recommendation 232 may be associated with a sustainable item and each of the second recommendation 234, the third recommendation 236, and the fourth recommendation may be associated with non-sustainable items. For example, the recommendation computing system 120 may determine the associated user has a medium propensity for conversion to sustainability and generate recommendations for items that includes on sustainable item based on the determined medium propensity for conversion to sustainability. In another example, if the recommendation computing system 120 determines the user has a high propensity for conversion to sustainability, each of the recommendations may be recommendations for the user to purchase sustainable items. The sustainable item may include sustainable ingredients or elements (e.g., plant based ingredients, plant based containers, environmentally friendly ingredients, etc.) and the non-sustainable items may include non-sustainable ingredients or elements (e.g., cow's milk, animal meat, etc.). For example, the first recommendation 232 includes a recommendation for an iced coffee with almond milk, the second recommendation 234 may include a recommendation for an americano with cow's milk, the third recommendation may include a recommendation for a coffee with cow's milk, and the fourth recommendation may include a recommendation for a seltzer packaged in a plastic housing (while the seltzer may be sustainable, the plastic housing may result in the item being classified as non-sustainable and/or having a low sustainability ranking).

It will be understood that FIGS. 2A-2D are provided for purposes of example, and that the present disclosure is not limited to a particular user interface or interfaces. It will further be understood that the user interfaces may be combined, divided, or reorganized within the scope of the present disclosure. For example, the user interfaces 210 and 220 may be combined, and an interface may be presented that includes both a recommendation for a sustainable food item and a recommendation for a sustainable drink item. As a further example, the user interface 230 may include some or all of the user interface elements depicted in FIG. 2B (e.g., the text identifying the sustainable item), and these elements may be displayed in a disabled or generic configuration. FIGS. 2A-2D are thus understood to be illustrative and not limiting.

### Process for Generating Recommendations

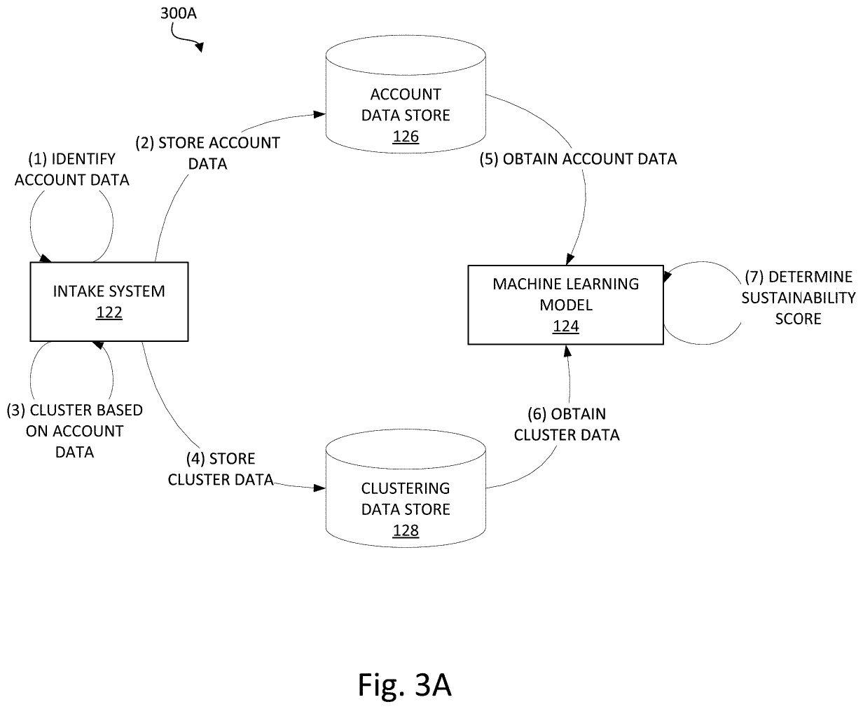

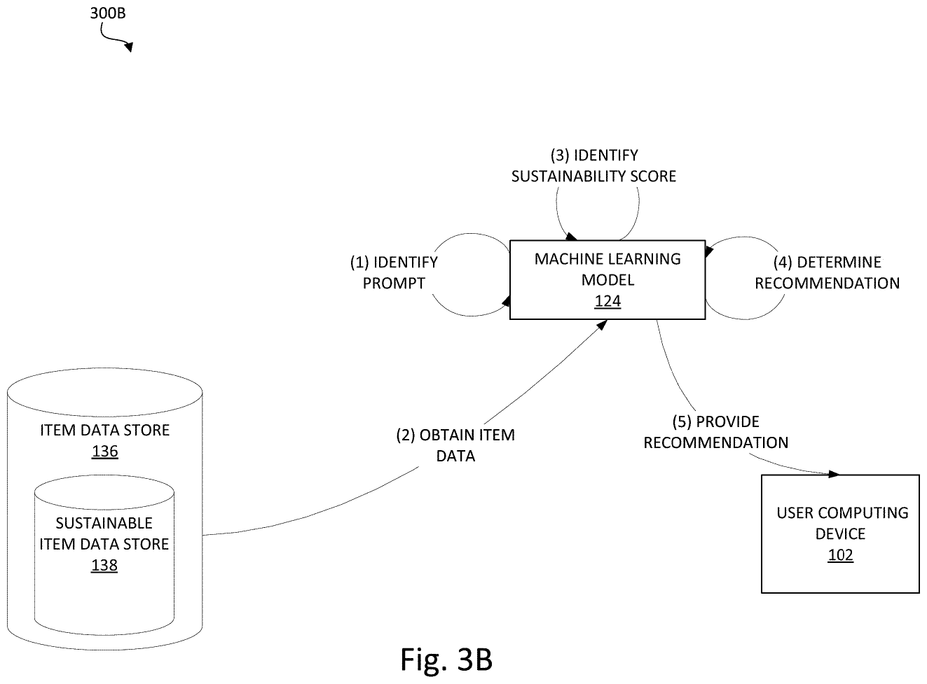

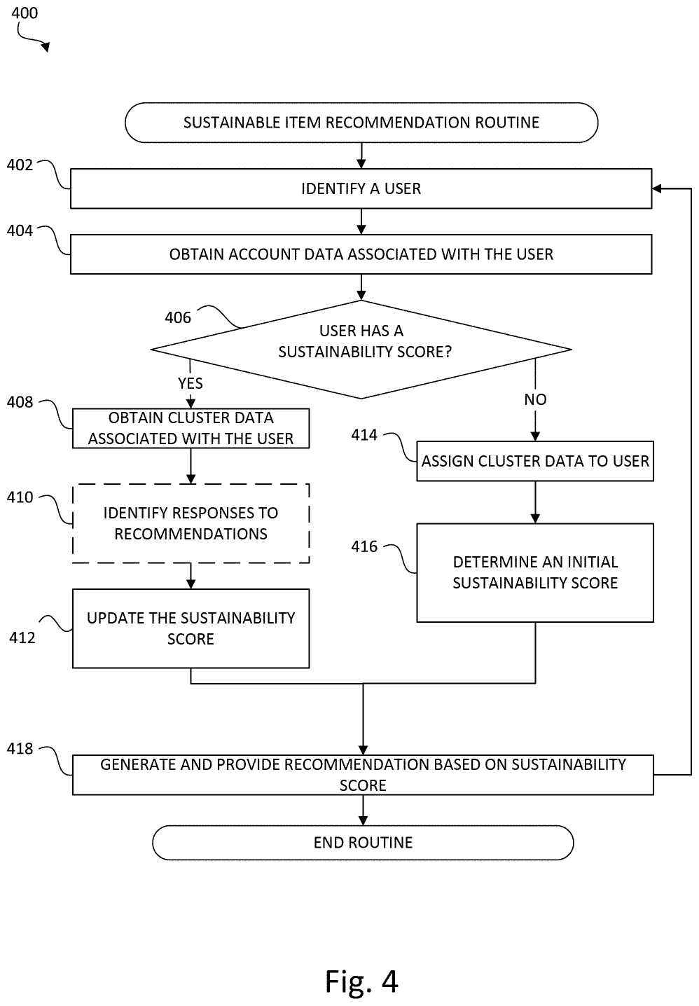

To further illustrate how the recommendation computing system may determine a propensity for conversion to sustainability for a user or a store, FIG. 3A depicts illustrative interactions 300A for generating a sustainability score for a user, including identifying account data and clustering based on the account data. The interactions 300A of FIG. 3A may occur, for example, after a user has registered with a registration computing system associated with the recommendation computing system. Further, the interactions 300A may occur prior to or after purchases of items by the user. It will be understood that while FIG. 3A, FIG. 3B, and FIG. 4 reference the generation of a sustainability score and a recommendation for a particular user, the disclosed systems may generate a sustainability score and a recommendation for a store, a worker associated with a store, etc.

The interactions of FIG. 3A begin at (1), where an intake system 122 identifies account data associated with a user. The intake system 122 may identify the account data based on an account identifier associated with the user (e.g., a user name, an e-mail address, etc.). In some embodiments, the intake system 122 may receive at least a portion of the account data via an account registration process. For example, the user, via a user computing device, may register an account with an account registration system. In registering the account, the user, via the user computing device, may provide particular account data (e.g., locations, date of birth, gender, and/or other identifying information of the user). Further, the intake system 122 may periodically identify additional account data. For example, the intake system 122 may obtain account data from the user computing device or from a separate computing device. The additional account data may include one or more updates to the account data. Further, the additional account data may include additional data (e.g., a location, a purchase history of the user, or any additional identifying information of the user). Therefore, the intake system 122 can identify (e.g., obtain) account data associated with a particular user.

Based on identifying the account data, at (2), the intake system 122 stores the account data in the account data store 126. The intake system 122 may store the account data and the account data may identify characteristics of the user. Further, the intake system 122 may store the account data with an account identifier of the user. The intake system 122 may store a plurality of account data for the user. In some embodiments, the intake system 122 may store account data that applies to multiple users. For example, a portion of account data (e.g., a location, etc.) may be the same for a first user and a second user.

To identify users associated with the user, at (3), the intake system 122 clusters the user based on the account data. Based on the account data, the intake system 122 may identify the characteristics associated with the user. Using the characteristics associated with the user, the intake system 122 may compare the characteristics with one or more clusters of users. To generate the clusters of users, the intake system 122 (or another computing system) may identify users that share particular characteristics. The characteristics shared by the users may include any granularity of characteristics. For example, the intake system 122 may generate a cluster of users who purchased a particular beverage in the past year, a cluster of users within a particular location, etc. The intake system 122 may periodically or aperiodically generate and/or update the clusters of users. In some embodiments, the intake system 122 may include a machine learning model to automatically cluster the user into particular clusters of users. Each of the one or more clusters of users may identify a group (e.g., a cluster of users) that share (e.g., have in common) particular characteristics (e.g., a location, similar purchases, etc.). Based on comparing the characteristics with the one or more clusters of users, the intake system 122 (or another component of the recommendation computing system) may identify clusters of users that are associated with the user. For example, the intake system 122 may compare the characteristics of the user with characteristics of the one or more clusters of users to determine if the characteristics are the same or are within a particular range and add the user to a particular cluster based on the determination. The intake system 122 may generate cluster data that identifies the clusters of users that are associated with the user.

Based on identifying the cluster data, at (4), the intake system 122 stores the cluster data in the clustering data store 128. The intake system 122 may store the cluster data to identify users that are related to or associated with the user. Further, the intake system 122 may store the cluster data with an account identifier of the user and/or account identifiers of the users identified by the cluster data.

To determine the sustainability score, at (5), a machine learning model 124 obtains the account data from the account data store 126. The machine learning model 124 may obtain the account data from the account data store 126 and parse the account data to identify a particular portion of the account data associated with the user (e.g., previous item purchases of the user). Further, the machine learning model 124 may identify account data associated with the user based on an account identifier. Therefore, the machine learning model 124 may obtain the account data based on the account identifier.

Further, at (6), the machine learning model 124 obtains the cluster data from the clustering data store 128. The machine learning model 124 may obtain the cluster data from the account data store 126 and parse the cluster data to identify a particular portion of the cluster data associated with the user (e.g., previous item purchases of users associated with the user). Further, the machine learning model 124 may identify cluster data associated with the user based on an account identifier. Therefore, the machine learning model 124 may obtain the cluster data based on the account identifier.

Based on the cluster data and the account data, at (7), the machine learning model 124 determines the sustainability score for the user. The recommendation computing system may identify and/or generate the cluster data and the account data based on observing the user and users associated with the user (e.g., user within the same or similar clusters). Based on observing the user and the users associated with the user, the machine learning model 124 may determine the sustainability score for the user. The sustainability score for the user may identify the probability or propensity for a user to purchase a sustainable item based on a recommendation. In some embodiments, the sustainability score for the user may identify the probability or propensity for a user to purchase a sustainable item that the user has not previously purchased. Further, the sustainability score for the user may identify the probability or propensity for a user to purchase a sustainable item when the user may not have previously purchased any sustainable items. The sustainability score for the user may be indicative of a propensity that a particular user will convert to purchasing sustainable items.

In order to determine the sustainability score for the user, the recommendation computing system may implement reinforcement learning. The recommendation computing system may implement a particular function (e.g., an observer function). The function may analyze the account data of a user (e.g., the previous purchases by the user) to determine if the user is immutable (e.g., unlikely to buy new items) or mutable (likely to buy new items). The machine learning model 124 may also determine the sustainability score based on the determined mutability of the user.

The sustainability score for the user may include a particular probability or a particular ranking. For example, the sustainability score may include or identify a probability (e.g., 60%) that a user will respond to a recommendation to purchase a sustainable item by purchasing the sustainable item. Further, the sustainability score may include or identify a ranking (e.g., a 4 on a scale of 1 to 10, where 1 represents a low propensity and 10 represents a high propensity) of the propensity for conversion to sustainability for the user.

In order to generate the sustainability score, the machine learning model 124 may receive, as input, the account data and/or the cluster data of the user. Based on the input, the machine learning model 124 can output the sustainability score. The machine learning model 124 may be trained on a plurality of account data and/or cluster data (e.g., a training data set). For example, the training data set may identify data associated with a plurality of users (e.g., historical data of users) and responses to recommendations to purchase sustainable items (e.g., the user did not purchase the sustainable item or did purchase the sustainable item). Based on the training data set, the machine learning model 124 may be trained to identify a sustainability score for a user based on account data and/or cluster data. In some embodiments, the machine learning model 124 may be periodically retrained (e.g., updated) based on receiving updated data, such as additional interaction data received from the user. For example, the machine learning model 124 may determine that a particular user has a 95% propensity for conversion to sustainability and, based on determining that the user, in response to a recommendation to purchase the sustainable item, did not purchase the sustainable item, the machine learning model 124 may determine that the model should be retrained.

To further illustrate how the recommendation computing system may generate a recommendation for a particular user based on the determined sustainability score for the user, FIG. 3B depicts illustrative interactions 300B for generating a recommendation for a user, including identifying a sustainability score and item information. The interactions 300B of FIG. 3B may occur, for example, after a user has registered with a registration computing system associated with the recommendation computing system. Further, the interactions 300B may occur prior to or after purchases of items by the user.

The interactions of FIG. 3B begin at (1), a machine learning model 124 identifies a prompt. The prompt may include a prompt from a computing device 102 and/or a third party computing device 104. The prompt may identify that a user, associated with the computing device 102 and/or the third party computing device 104, is accessing a particular interface, is within a particular distance of a particular device, etc. For example, the prompt may identify that the user is accessing a particular website that includes an advertisement associated with the recommendation computing system. Further, the prompt may identify that the user is accessing a particular interface associated with the recommendation computing system. Based on the prompt, the machine learning model 124 may determine that a recommendation should be generated for the user. Further, the machine learning model 124 may determine to generate the recommendation as an advertisement for display via the computing device 102 (e.g., via an API, via a website, etc.), via the third party computing device 104, or via any other computing device. The machine learning model 124 may identify the prompt and determine to generate a recommendation. The machine learning model 124 can use a machine learning model to generate the recommendation.

To identify item data including non-sustainable item data and/or sustainable item data, at (2), the machine learning model 124 obtains the item data from the item data store 136 and/or the sustainable item data store 138. The machine learning model 124, based on identifying the prompt and determining that a recommendation should be generated, may obtain the item data. The machine learning model 124 may receive the item data as a plurality of item data. Further, each subset of the item data may be associated with a non-sustainable item identifier or a sustainable item identifier. Further, each subset of the item data may be associated with a sustainable ranking that identifies how sustainable a particular item is. A computing system may receive the item data and generate the non-sustainable item identifiers and sustainable item identifiers for each subset of the item data. In some embodiments, the recommendation system may be configured to determine a sustainability ranking based on the ingredients of the item. The sustainability ranking may be indicative of whether the particular item is sustainable or non-sustainable. In some embodiments, as item data is added to the item data store 136 and/or the sustainable item data store 138, the sustainable item identifiers and the non-sustainable item identifiers may also be added to the item data store 136 and/or the sustainable item data store 138.

The machine learning model 124 may obtain all of the item data or a portion of the item data. For example, the machine learning model 124 may determine that the user is interested in food items based on the prompt and obtain item data that is associated with food items. Further, the machine learning model 124 may obtain the item data from the item data store 136 and parse the item data to identify a particular portion of the item data associated with the prompt.

In some embodiments, the machine learning model 124 stores a sustainability score in the conversion data store 130. The machine learning model 124 may store the sustainability score in order to identify the probability for conversion for a particular user. The machine learning model 124 may further store the sustainability score with an account identifier associated with the user. Further, the machine learning model 124 in response to generating the sustainability score (e.g., as discussed in FIG. 3A). The machine learning model 124 may periodically or aperiodically generate a sustainability score for the user. Further, the machine learning model 124 may update the stored sustainability score for the user. The machine learning model 124 may store the sustainability score for the user as conversion data (e.g., conversion data associated with the user).

Based on identifying the prompt, at (3), the machine learning model 124 identifies the sustainability score (e.g., from conversion data stored in the conversion data store 130). The machine learning model 124 may obtain the sustainability score from the conversion data store 130, such as the sustainability score for the user, associated with the user's account identifier. The machine learning model 124 may obtain the sustainability score based on the account identifier.

Based on the sustainability score and the item data, at (4), the machine learning model 124 determines a recommendation for the user. The machine learning model 124 may generate the recommendation (or a plurality of the recommendations) for the user based at least in part on the sustainability score, the account data, the cluster data, and/or the item data for the user. The recommendation for the user may include a recommendation for the user to purchase a sustainable item and a recommendation for the user to purchase a non-sustainable item. In some embodiments, the recommendation for the user may only include recommendations for the user to purchase sustainable items or only include recommendations for the user to purchase non-sustainable items. The machine learning model 124 can generate a plurality of recommendations for the user. The ratio between recommendations for the user to purchase sustainable items and the recommendations for the user to purchase non-sustainable items may be based on the sustainability score for the user. The recommendations for the user to purchase sustainable items may be based on sustainable item data obtained from the item data store 136 and the recommendations for the user to purchase non-sustainable items may be based on non-sustainable item data obtained from the item data store 136.

For example, the machine learning model 124 may determine that the user is likely to enjoy an americano based on previous item purchases by the user (e.g., the user purchasing an americano or a similar item) and may recommend that the user purchase an americano. Further, the machine learning model 124 may determine a sustainable version and/or a non-sustainable version of the item and determine whether to recommend the sustainable item or the non-sustainable item.

As the user may be less likely to respond positively (e.g., purchase the item) to a recommendation for a sustainable item as compared to a recommendation for a non-sustainable item, the machine learning model 124 may generate the recommendation for the user based on an identified goal or threshold (e.g., a sustainability goal). For example, the machine learning model 124 may identify a sustainability goal that identifies a goal to increase sustainability (e.g., to reduce methane emissions by reducing dependence on cows), maintain sustainability, emphasize other factors, or other identified goals. Based on the identified goals, the machine learning model 124 may determine a propensity threshold. For example, if the sustainability goal is to increase sustainability, the propensity threshold may be easier to satisfy, such as a lower threshold (e.g., 50%), and if the sustainability goal is to emphasize other factors (such as profit), the propensity threshold may be more difficult to satisfy, such as a higher threshold (e.g., 85%). The machine learning model 124 may compare the sustainability score for the user to the propensity threshold in order to generate the recommendations. If sustainability score for the user matches and/or surpasses the propensity threshold, the machine learning model 124 may generate a recommendation that includes a recommendation for at least one sustainable item (e.g., based on the difference between the sustainability score and the propensity threshold). In the event that the sustainability score for the user does not match and/or surpass the propensity threshold, the machine learning model 124 may generate a recommendation that does not include a recommendation for at least one sustainable item. In some embodiments, the sustainability score for the user may be used to determine a number of sustainable item recommendations for the user. For example, the machine learning model 124 may generate a recommendation including a base number of sustainable item recommendations for the user (e.g., one sustainable item recommendation), and generate additional recommendations as the propensity increases.

In some embodiments, in generating the recommendation, the machine learning model 124 may balance multiple goals. For example, the machine learning model 124 may balance a sustainability goal and a profitability goal. The machine learning model 124 may generate the propensity threshold based on a determined balance between the sustainability goal and the profitability goal. For example, the machine learning model 124 may generate the propensity threshold based on a determined priority of the sustainability goal and/or the profitability goal (e.g., the machine learning model 124 may determine that the sustainability goal has a higher priority than the profitability goal and adjust the priority threshold based on the determination).

The recommendation for the user may include one or more economic rewards or offers. For example, the recommendation for the user may include a coupon or discount on a particular item (e.g., a sustainable item). The recommendation may include the one or more economic rewards or offers in order to encourage the user to purchase the item (e.g., to encourage the user to purchase the sustainable item). The machine learning model 124 (or a separate computing system) may further generate a program of offers or rewards for the user based on the recommendation for the user. For example, users who are identified as immutable and/or have a low sustainability score may receive offers or rewards with few or no recommendations (or infrequent recommendations) to change (e.g., to purchase new sustainable items) while users who are identified as mutable and/or have a high sustainability score may receive offers or rewards with many recommendations (or frequent recommendations) (e.g., all recommendations for the user) to change.

Based on the recommendation for the user, at (5), the machine learning model 124 provides the recommendation for the user to a computing device 102 associated with the user. Further, the machine learning model 124 may provide the recommendation to a third party computing device 104 for display to and/or communication to the user.

In response to receiving the recommendation, the computing device 102 may display the recommendation. For example, the computing device 102 may display the recommendation via an interface (e.g., an API, a CLI, or any other interface). Further, the computing device 102 may display the recommendation via a web page, a mobile API, a voice interface, a digital menu board, a drive-thru menu board, or any other interface for the computing device. A third party computing device 104 may also display the recommendation and prompt a third party (e.g., a waitress or cashier) to inform the user of the recommendation (e.g., the offer).

The recommendation computing system may conduct further reinforcement learning (e.g., ongoing reinforcement learning). The further reinforcement learning may be a feedback loop that enables the recommendation computing system to perform training based on responses by users to offers. The recommendation computing system may monitor account data associated with the user to identify interactions by the user with the recommendation (e.g., the offer). If the recommendation computing system determines the user responded well to a particular recommendation for a sustainable item (e.g., purchased the recommended item or a similar item) and/or was influenced by the recommendation, the recommendation computing system may adjust the account data for the user and generate additional recommendations for sustainable items for the user. If the recommendation computing system determines the user did not respond well to a particular recommendation for a sustainable item (e.g., did not purchase the recommended item or a similar item) and/or was not influenced by the recommendation, the recommendation computing system may adjust the account data for the user and may generate fewer or no recommendations for sustainable items for the user. The feedback system can be used to continually update a user's sustainability score.

With reference to FIG. 4, an illustrative routine 400 will be described for a sustainable item recommendation. The routine 400 may be implemented for example, by the recommendation computing system 120 of FIG. 1. The routine 400 begins at block 402, the recommendation computing system 120 identifies a user. The recommendation computing system 120 may identify a user based on a prompt from the user, a registration by the user, use of a computing application, or other method for recognizing a user. For example, the prompt by the user may include a request to purchase a particular item on an application, an indication that the user is browsing the particular item, a purchase of the particular item, and the like.

At block 404, the recommendation computing system 120 obtains account data associated with the user. The account data associated with the user may identify one or more characteristics of the user (e.g., one or more carbon neutral and/or one or more carbon negative characteristics of the user). Further, the account data may include previous item purchases of the user. The account data may include a plurality of recency, frequency, and monetary values associated with the previous item purchases. In some embodiments, where the user is associated with a sustainability score, the recommendation computing system 120 may generate a plurality of recency, frequency, monetary, and sustainability values for the user based on the sustainability score of the user and update the account data associated with the user based on the plurality of recency, frequency, monetary, and sustainability values. Further, the recommendation computing system 120 may determine a mutability (e.g., a probability of the user to purchase a different or previously unpurchased item) of the user based on the previous item purchases of the user.

At block 406, the recommendation computing system 120 determines if the user has a sustainability score. The sustainability score may identify a propensity for a user to purchase a previously unpurchased sustainable item as opposed to repurchasing a non-sustainable item. The sustainable item and the non-sustainable may include food items and/or beverage items. Further, the sustainable item may include a carbon neutral or a carbon negative item and the non-sustainable item may include a carbon positive item.

Based on determining the user has a sustainability score, at block 408, the recommendation computing system 120 obtains cluster data (e.g., metadata) associated with the user. The cluster data may identify one or more clusters of users from a plurality of users. Each of the one or more clusters of users may include the user. Further, the one or more clusters of users may be based on a geographical location of the user (e.g., a geographical location of the user computing device of the user), a status of the user, etc. In some embodiments, prior to obtaining the cluster data, the recommendation computing system 120 may identify the one or more clusters of users based on the account data associated with the user and assign the user to the one or more clusters of users. For example, the recommendation computing system 120 may assign the user to generate an initial sustainability score and/or an initial recommendation for the user. In other embodiments, a separate computing system may assign the user to the one or more clusters of users. Therefore, the recommendation computing system 120 may obtain the cluster data identifying one or more clusters of users to which the user has been assigned.

At block 410, the recommendation computing system 120 may identify responses to the recommendation. For example, the recommendation computing system 120 may determine if the user accepted or rejected a recommendation to purchase a particular sustainable item. The responses by the user to the prior recommendation may be stored as the one or more characteristics from the account data.

At block 412, optionally, the recommendation computing system 120 updates the sustainability score. In order to update the sustainability score, the recommendation computing system 120 may perform reinforcement learning to dynamically adjust the sustainability score. The recommendation computing system 120 may update the sustainability score or generate a new sustainability score by accessing a machine learning model for generating the sustainability score. The sustainability score may identify a probability of the user to purchase sustainable items. In order to generate the sustainability score, the machine learning model may parse the account data associated with the user to generate a sustainability score based on the one or more characteristics of the user and may generate the sustainability score based on the sustainability score. Further, the machine learning model may parse the cluster data to generate a second sustainability score and generate the sustainability score based on the sustainability score and the second sustainability score. For example, the second sustainability score may be based on a probability of another user of the one or more clusters of users to purchase a sustainable item. In some embodiments, the recommendation computing system 120 may generate the sustainability score based on the mutability of the user.

Based on determining the user does not have a sustainability score, at block 414, the recommendation computing system 120 assigns cluster data (e.g., metadata) to the user. The recommendation computing system 120 may identify additional account data associated with the user. For example, the recommendation computing system 120 may identify a geographical location of the user (e.g., a geographical location of the user computing device of the user), a status of the user, a temperature associated with the geographical location of the user, a weather associated with the geographical location of the user, a preference of the user (e.g., a preference for baked goods), or any other information associated with this user. The recommendation computing system 120 may identify one or more clusters of users that share similar characteristics with the user based on the account data associated with the user. The recommendation computing system 120 may identify a user with account data with values that are the same or within a particular range of values of a cluster of users. For example, the recommendation computing system 120 may determine a user computing device associated with a user is located at a particular location in Springfield, Ill. and the cluster of users may include users who have placed orders via respective user computing devices, when the respective user computing devices are located within 25 miles of the location of the user's user computing device in Springfield, Ill. The recommendation computing system 120 may add the user to the one or more clusters of users. For example, the recommendation computing system 120 may determine the user computing device of the user is located in New York City, N.Y. and may assign the user to a cluster of users who have utilized respective user computing devices to place orders, navigate an application, etc. while the respective user computing devices are located in New York City, N.Y. Therefore, the recommendation computing system 120 may assign particular cluster data associated with one or more clusters of users to the user based on adding the user to the one or more clusters of users.

At block 416, the recommendation computing system 120 determines an initial (e.g., a base) sustainability score. The recommendation computing system 120 may determine the initial sustainability score based on the assigned cluster data for the user. The recommendation computing system 120 may determine the initial sustainability score based on account data associated with the user. In some embodiments, the recommendation computing system 120 may determine that the user is not associated with account data (e.g., the user has not uploaded any account data) and may determine a base sustainability score (e.g., 0%, 50%, etc.). The base sustainability score based on an average sustainability (e.g., the average propensity for the average user to convert to sustainability).

At block 418, the recommendation computing system 120 generates and provides a recommendation based on the sustainability score. Prior to generating the recommendation, the recommendation computing system 120 may determine that the sustainability score exceeds a threshold (e.g., a dynamic threshold) and may generate the recommendation based on the sustainability score exceeding the threshold. In some embodiments, generating and providing the recommendation may include adjusting a prior recommendation for a non-sustainable item to a recommendation for a sustainable item based on the sustainability score. Further, the recommendation computing system 120 may generate a plurality of recommendations for the user including the recommendation. The plurality of recommendations may include recommendations to purchase non-sustainable items and at least one sustainable item based on the sustainability score. Further, the recommendation computing system 120 may cause display, via display of a computing device associated with the user, of the plurality of recommendations. The plurality of recommendations may be based on previous item purchases of the user of a non-sustainable item and/or a sustainable item.

In various embodiments, the stateful execution routine 400 may include more, fewer, different, or different combinations of blocks than those depicted in FIG. 4. For example, the routine 400 may, in some embodiments, output of the sustainability. As a further example, blocks 402 and 404 may be combined, and the routine 400 may identify the user without separately obtaining the account data. The routine 400 depicted in FIG. 4 is thus understood to be illustrative and not limiting.

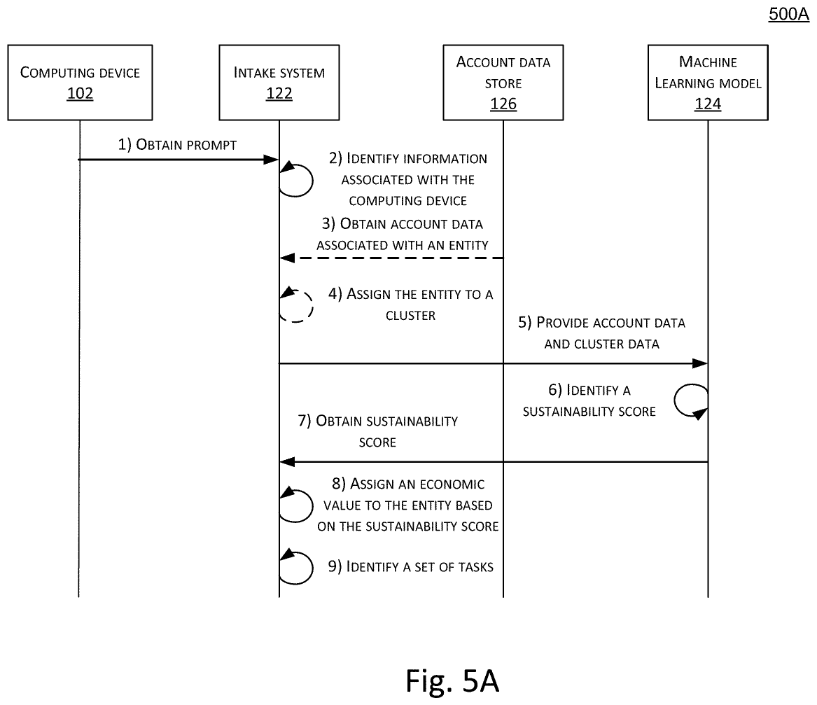

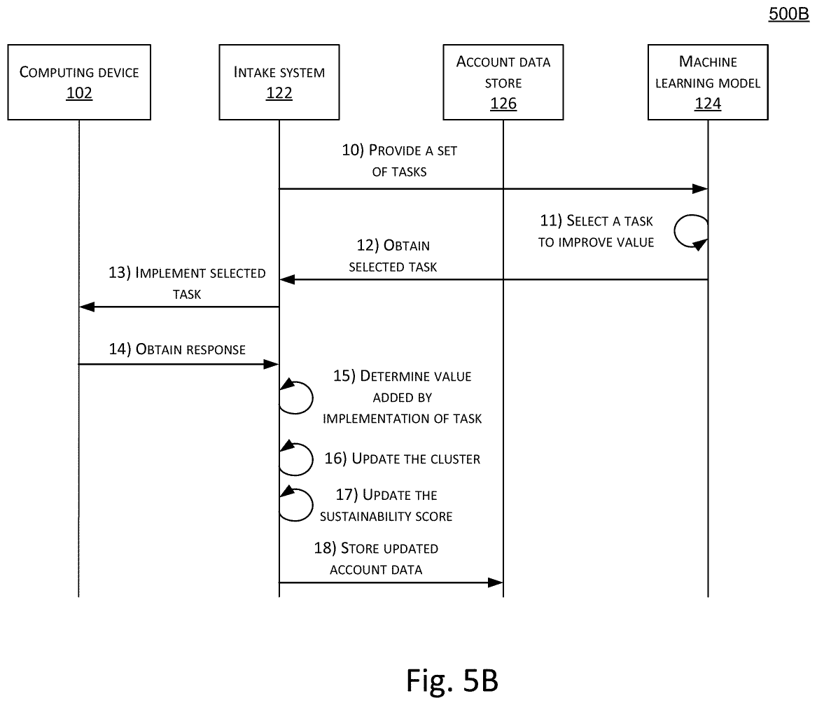

FIG. 5A depicts interactions among various components shown in FIG. 1 for assigning a sustainability score to an entity and identifying tasks to improve the value of the entity in accordance with aspects of the present disclosure. The environment 500A may include various components implemented in a configuration as identified in FIG. 1. The environment 500A may include a computing device, 102, an intake system 122, an account data store 126, and a machine learning model 124. In some embodiments, the recommendation computing system 120 may implement (e.g., execute) the intake system 122, the account data store 126, and/or the machine learning model 124. In other embodiments, a separate computing system 120 may implement one or more of the computing device 102, the intake system 122, the account data store 126, and/or the machine learning model 124. It will be understood that the environment 500A may include more, less, or different components.

As shown in FIG. 5A at [1], the intake system 122 obtains a prompt from the computing device 102. The intake system 122 may receive a prompt from the computing device 102 identifying an entity (e.g., a store, a customer, a user, etc.) associated with the computing device 102. The intake system 122 may receive the prompt during a registration by the computing device 102 with the intake system 122. The intake system 122 may receive the prompt when an entity logs into, via the computing device 102, an application associated with the intake system 122. Further, the prompt may be based on location information. For example, the intake system 122 may obtain a prompt from the computing device 102 based on determining that the computing device 102 is at a certain location or within a particular range of a certain location (e.g., a billboard, a store, an advertisement, etc.). In some embodiments, the prompt may be based on timing information. For example, the intake system 122 may obtain the prompt from the computing device 102 every 24 hours. The intake system 122 may receive the prompt over a network. Therefore, the intake system 122 can obtain a prompt from the computing device 102.

At [2], the intake system 122 can identify information associated with the computing device 102 based on the prompt. The intake system 122 can identify a type of the computing device 102 (e.g., a cell phone, a tablet, a laptop, etc.), a context of the prompt (e.g., an account registration, an account login, a proximity based prompt, etc.), or any other information associated with the computing device 102. Therefore, the intake system 122 can identify information associated with the computing device 102.

At [3], the intake system 122 may obtain account data associated with an entity from the account data store 126. The intake system 122 may request the account data associated with the entity from the account data store 126. In some embodiments, the account data store 126 may not store any account data associated with the particular entity. The intake system 122 may further request account data based on the information associated with the computing device 102. For example, the intake system 122 may obtain account data that is based on the context of the prompt (e.g., an entity logging in to purchase an item). The intake system 122 can obtain account data including a history (e.g., a purchase history, a sale history, etc.) associated with the entity, attributes (e.g., frequently purchased or sold items), or any other account data. In some embodiments, the account data may include a sustainability score for the entity. Therefore, the intake system 122 can obtain account data.

At [4], the intake system 122 may assign the entity to a cluster (or multiple clusters) of a plurality of clusters. Based on assigning the entity to the cluster, the intake system 122 may generate cluster data identifying the particular cluster. In some embodiments, the intake system 122 may not assign the entity to a cluster and may identify a previously assigned cluster for the entity. The intake system may generate cluster data identifying the previously identified cluster. As discussed above, each of the plurality of clusters may include one or more entities and the intake system 122 may assign the entity to a particular cluster based on the account data, an economic value/sustainability score associated with the entity (e.g., one or more recency, frequency, monetary, and sustainability values), or any other information associated with the entity such that entities with similar data are grouped in the same clusters. In some embodiments, the account data may indicate that the entity was previously assigned to one or more clusters. The intake system 122 may update the previously assigned one or more clusters. Therefore, the intake system 122 can assign the entity to a particular cluster.

At [5], the intake system 122 provide the account data and/or cluster data to the machine learning model 124. As discussed above, the intake system 122 can provide the account data and/or the cluster data to the machine learning model 124 to generate a sustainability score for the entity. Therefore, the intake system 122 can provide the account data and/or the cluster data to the machine learning model 124. At [6], the machine learning model 124 identifies a sustainability score. The machine learning model 124 may be trained to identify a sustainability score for the entity using a training data set. The machine learning model 124 may assign the sustainability score to the entity based on the obtained account data and/or the obtained cluster data. The machine learning model 124 may use the sustainability score to update a previous sustainability score. In some embodiments, the sustainability score may be an initial sustainability score for the entity. At [7], the intake system 122 obtains the sustainability score from the machine learning model 124. The sustainability score may be a numerical, symbolical, alphabetical, and/or alphanumerical term. Therefore, the intake system 122 can obtain the sustainability score from the machine learning model 124.

At [8], the intake system 122 assigns an economic value to the entity based on the sustainability score. The economic value may be one or more recency, frequency, and monetary values associated with the entity. The economic value may be based on the account data identified by the intake system 122. The intake system 122 (or a separate system) may utilize the economic value in reward logic (e.g., in generating rewards for entities). For example, based on the economic value associated with an entity, the intake system 122 may offer particular customized rewards and/or benefits (e.g., coupons, free delivery, different services, etc.). For example, entities that purchase more items than other entities may be offered more coupons than other entities to encourage the purchasing behavior of the entities. The intake system 122 may link (e.g., pair) the economic value to the sustainability score. By linking the economic value to the sustainability score, the intake system 122 may generate a value of the entity (e.g., one or more recency, frequency, monetary, and sustainability values associated with the entity). In some embodiments, the intake system 122 may update a previous value of the entity (e.g., a previous value of the entity generated by the intake system 122). The intake system 122 may utilize the value of the entity in the reward logic such that the sustainability score is incorporated in to the reward logic. Therefore, the intake system 122 can assign an economic value to the entity based on the sustainability score.

The intake system 122 may identify a value (e.g., a recency, frequency, monetary, and/or sustainability value) of the cluster assigned to the entity. In some embodiments, the intake system 122 may assign the entity to a particular cluster based on the value of the entity. The intake system 122 may observe (e.g., identify) one or more potential tasks for transitioning the entity, based on the cluster assigned to the entity, to a higher recency, frequency, monetary, and sustainability value. Each of the tasks may be associated with a predicted increase in value based on the implementation of the task. For example, a first task to recommend the purchase of an oat milk latte may have a predicted increase in value of the entity of +1 and a second task to provide a buy one, get one free coupon for purchase of a vegetarian sandwich may have a predicted increase in value of the entity of +5. To determine the one or more potential tasks for transitioning the entity, the intake system 122 may access a catalog of items including a plurality of items and sustainability scores associated with the items.

At [9], the intake system 122 identifies a set of tasks. The intake system 122 may identify the set of tasks from the one or more potential tasks identified by the intake system 122. To identify the set of tasks, the intake system 122 may identify information associated with a particular store, a particular user, the intake system 122, etc. For example, the intake system 122 may identify information associated with a particular store linked to the entity (e.g., a store that is located closest to the entity of a plurality of stores). The intake system 122 may identify particular tasks that can be completed at the store and particular tasks that cannot be completed at the store (e.g., based on worker availability, item availability, machines at the store, etc.). The intake system 122 may not include tasks in the set of tasks that cannot be completed at the store. For example, the intake system 122 may not include a recommendation and/or a coupon to purchase a nitro cold brew at a store that does not have a nitro cold brew machine, does not have the ingredients for a nitro cold brew, and/or does not have a sufficient number of workers to complete a nitro cold brew purchase. The intake system 122 may also identify particular tasks based on the information associated with a user. For example, a user may indicate that they will not purchase almond milk and the intake system 122 can remove any task associated with almond milk from the set of tasks. The intake system 122 may also identify particular tasks based on the information associated with the intake system 122. For example, the intake system 122 may receive instructions to not generate tasks associated with almond milk (e.g., based on a recall of almond milk) and the intake system 122 may remove any task associated with almond milk from the set of tasks. Therefore, the intake system 122 can identify the set of tasks.

FIG. 5B depicts interactions among various components shown in FIG. 1 for recommending particular tasks for a particular entity and updating a sustainability score based on the task in accordance with aspects of the present disclosure. The interactions of FIG. 5B may occur subsequent to the interactions [1]-[9] of FIG. 5A and may be based at least in part on the interactions [1]-[9] of FIG. 5A. The environment 500B may include various components implemented in a configuration as identified in FIG. 1. The environment 500B may include a computing device, 102, an intake system 122, an account data store 126, and a machine learning model 124. In some embodiments, the recommendation computing system 120 may implement (e.g., execute) the intake system 122, the account data store 126, and/or the machine learning model 124. In other embodiments, a separate computing system 120 may implement one or more of the computing device 102, the intake system 122, the account data store 126, and/or the machine learning model 124. It will be understood that the environment 500B may include more, less, or different components.

As shown in FIG. 5B at [10], the intake system 122 provides a set of tasks to the machine learning model 124. The intake system 122 may provide the set of tasks to the machine learning model 124 to optimize the value (e.g., the recency, frequency, monetary, and sustainability value) associated with the entity. The machine learning model 124 may be trained using a training data set to identify particular tasks based on the entity, the account data associated with the entity, the cluster(s) assigned to a particular entity, and/or the current value associated with the entity and a set of tasks. Therefore, the intake system 122 may provide the set of tasks to the machine learning model 124.

At [11], the machine learning model 124 selects a task from the set of tasks to improve the value (e.g., the recency, frequency, monetary, and sustainability value) associated with the entity. The machine learning model 124 may identify a particular task from the set of tasks based on the information associated with the entity (e.g., the account data, the sustainability score, the current value, the cluster(s) assigned to the entity, etc.) and/or the predicted increase in value for the entity for each task. Therefore, the machine learning model 124 can select a particular task from the set of tasks.

At [12], the intake system 122 obtains the task from the machine learning model 124. The task may include the display of a particular interface to the entity. The interface may include a recommendation/prompt to purchase a particular item, a coupon to purchase a particular item, a reward for purchasing a particular item (e.g., more reward points), or any other interface. For example, the interface may include a prompt to purchase a cashew milk latte. Therefore, the intake system 122 can obtain a task from the machine learning model 124.

At [13], the intake system 122 implements the task at the computing device 102. The intake system 122 may implement the task by causing display of the interface at the computing device 102. In some embodiments, the intake system 122 may implement the task by causing display of the interface at a different computing device (e.g., an electronic billboard, an in-store kiosk and/or banner, a different user computing device, etc.). Therefore, the intake system 122 can implement the task at the computing device 102.

At [14], the intake system 122 obtains a response to the task from the computing device 102. The intake system 122 may obtain the response from the computing device 102 and determine an interface that was displayed via the computing device 102. In some embodiments, the intake system 122 may obtain the response from a different computing device that displayed the interface. Based on the interface that was displayed by the computing device 102, the intake system 122 may determine the information that was displayed (e.g., the particular prompt, recommendation, coupon, reward offer, etc. that was displayed for the particular entity). Therefore, the intake system 122 can obtain the response to the task from the computing device 102.

At [15], the intake system 122 determines a value added by the task. The intake system 122 may determine a value added to the entity (e.g., an increase in the recency, frequency, monetary, and sustainability value) based on the implementation of the task. The intake system 122 may monitor, in real time or periodically, the value associated with the entity and, based on the monitoring, may identify an increase in the value based on the implementation of the task. By identifying a value added to the entity based on the implementation of the task, the intake system 122 may identify how to increase the value of the entity and similar entities (e.g., entities assigned to the same cluster). Therefore, the intake system 122 may determine a value added by the task.

At [16], the intake system 122 updates the cluster. Based on the value added to the entity, the intake system 122 may reassign the entity to a new cluster. For example, the intake system 122 may reassign the entity to a cluster with a similar value to the entity. In some embodiments, the intake system 122 can store information identifying the reassignment of the entity to the cluster in a clustering data store. Therefore, the intake system 122 can update the cluster assigned to the entity.

At [17], the intake system 122 updates the sustainability score. The intake system 122 can update the sustainability score for the entity based on the value added to the entity. The intake system 122 may also update a sustainability score associated with the particular task implemented by the entity. The intake system 122 may generate updated account data including the updated sustainability score for the entity and/or the updated sustainability score for the task. Therefore, the intake system 122 can update the sustainability score.

At [18], the intake system 122 stores the updated account data in the account data store 126. The intake system 122 may store the updated account data and link the updated account data to the entity. In some embodiments, the intake system 122 may utilize the updated account data in order to determine one or more additional tasks for implementation. Therefore, the intake system 122 can store the updated account data in the account data store 126.

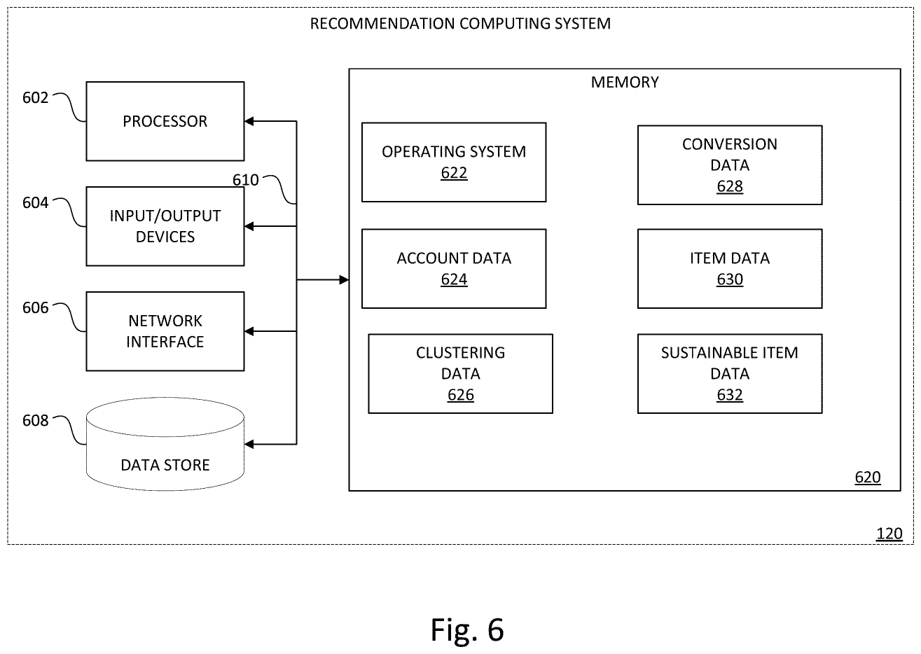

FIG. 6 depicts a general architecture of a recommendation computing system 120, which includes an arrangement of computer hardware and software components that may be used to implement aspects of the present disclosure. The recommendation computing system 120 may include many more (or fewer) elements than those shown in FIG. 6. It is not necessary, however, that all of these elements be shown in order to provide an enabling disclosure.

As illustrated, the recommendation computing system 120 includes a processor 602, input/output devices 604, a network interface 606, and a data store 608, all of which may communicate with one another by way of a communication bus 610. The network interface 606 may provide connectivity to one or more networks (such as the network 110 depicted in FIG. 1) or computing systems and, as a result, may enable the recommendation computing system 120 to receive and send information and instructions from and to other computing systems or services, such as the computing devices 102 or the third party computing devices 104 depicted in FIG. 1. In some embodiments, the recommendation computing system 120 may process prompts received from the computing devices 102 and/or the third party computing devices 104.

The processor 602 may also communicate to and from a memory 620. The memory 620 may contain computer program instructions (grouped as modules or components in some embodiments) that the processor 602 may execute in order to implement one or more embodiments. The memory 620 generally includes RAM, ROM, and/or other persistent, auxiliary, or non-transitory computer-readable media. The memory 620 may store an operating system 622 that provides computer program instructions for use by the processor 602 in the general administration and operation of the recommendation computing system 120. The memory 620 may further store specific computer-executable instructions and other information (which may be referred to herein as “modules”) for implementing aspects of the present disclosure. For example, the memory 620 may include account data 624, cluster data 626, conversion data 628, item data 630, and sustainable item data 632. In some embodiments, the account data 624, the cluster data 626, the conversion data 628, the item data 630, and/or the sustainable item data 632 may be obtained from internal or external data stores (e.g., the account data store 126 of FIG. 1), either directly or via the network 110.

It will be recognized that many of the components described in FIG. 6 are optional and that embodiments of the recommendation computing system 120 may or may not combine components. Furthermore, components need not be distinct or discrete. Components may also be reorganized. For example, the recommendation computing system 120 may be represented in a single physical device or, alternatively, may be split into multiple physical devices. In some embodiments, components illustrated as part of the recommendation computing system 120 may additionally or alternatively be included in other computing devices (such as the computing devices 102 of FIG. 1), such that some aspects of the present disclosure may be performed by the recommendation computing system 120 while other aspects are performed by another computing device.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). For example, the recommendation computing system may not obtain cluster data associated with the user. Further, the recommendation computing system may generate a recommendation for the user based on account data and not based on cluster data. Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. In addition, the separation of various system components in the implementations described above should not be understood as requiring such separation in all implementations, and it should be understood that the described components and systems can generally be integrated together in a single product or packaged into multiple products.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

In summary, various illustrative embodiments and examples have been disclosed. Although systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed:

1. A system to generate recommendations for a user, the system comprising:
a data store configured to store computer-executable instructions; and
a processor in communication with the data store, wherein the computer-executable instructions, when executed by the processor, cause the processor to:
identify account data associated with the user, the account data identifying one or more characteristics of the user;
access a machine learning model for generating a sustainability score of the user, wherein the sustainability score of the user is indicative of a propensity for conversion to sustainability of the user that identifies a probability of the user to purchase sustainable items, wherein to generate the sustainability score of the user, the machine learning model is configured to:
parse the account data associated with the user to identify the one or more characteristics of the user, and
generate the sustainability score of the user based on the one or more characteristics of the user;
generate a plurality of recommendations for the user, the plurality of recommendations comprising recommendations to purchase non-sustainable items and at least one sustainable item based on the sustainability score of the user; and
cause display, via a display of a user computing device associated with the user, of the plurality of recommendations.

2. The system of claim 1, wherein the plurality of recommendations are based on a previous item purchase of a plurality of previous item purchases, the previous item purchase corresponding to a non-sustainable item.

3. The system of claim 1, wherein the sustainability score of the user is a first sustainability score of the user, wherein the data store is further configured to store further machine-readable instructions that, when executed by the processor, cause the processor to:
identify metadata associated with the user, the metadata identifying one or more clusters of users, each of the one or more clusters of users comprising the user,
wherein the machine learning model is further configured to parse the metadata associated with the user to generate a second sustainability score of the user, wherein generating the first sustainability score of the user is based on the second sustainability score of the user.

4. The system of claim 3, wherein the one or more clusters of users are based on a geographical location of the user computing device, a preference of the user, or a status of the user.

5. The system of claim 3, wherein the second sustainability score of the user is based on a probability of another user of the one or more clusters of users to purchase the at least one sustainable item.

6. The system of claim 3, wherein the data store is further configured to store further machine-readable instructions that, when executed by the processor, cause the processor to:
identify the one or more clusters of users based on the account data;
add the user to the one or more clusters of users; and
generate the metadata based on adding the user to the one or more clusters of users.

7. The system of claim 1, wherein the non-sustainable items comprise a first food item or a first drink item and the at least one sustainable item is a second food item or a second drink item.

8. The system of claim 1, wherein the non-sustainable items comprise a carbon positive item and the at least one sustainable item is a carbon neutral item or a carbon negative item.

9. The system of claim 1, wherein the one or more characteristics of the user comprise a response by the user to a prior recommendation to purchase a particular sustainable item of the at least one sustainable item.

10. The system of claim 1, wherein a ratio of the non-sustainable items to the at least one sustainable item is based on the sustainability score of the user.

11. The system of claim 1, wherein to cause display of the plurality of recommendations, the computer-executable instructions, when executed by the processor, further cause the processor to:
cause display, via the display of the user computing device associated with the user, of a first recommendation of the plurality of recommendations during a first time period, the first recommendation comprising a recommendation to purchase a non-sustainable item; and
cause display, via the display of the user computing device associated with the user, of a second recommendation of the plurality of recommendations during a second time period, the second recommendation comprising a recommendation to purchase a sustainable item.

12. The system of claim 1, wherein the one or more characteristics of the user comprise one or more carbon neutral characteristics of the user or one or more carbon negative characteristics of the user.

13. The system of claim 1, wherein the data store is further configured to store further machine-readable instructions that, when executed by the processor, cause the processor to:
identify a response to the plurality of recommendations; and
adjust the sustainability score of the user based on the response.

14. The system of claim 1, wherein the user is a first user, the plurality of recommendations is a first plurality of recommendations, and the account data is first account data, wherein the data store is further configured to store further machine-readable instructions that, when executed by the processor, cause the processor to:
determine a second user is not associated with second account data;
generate a base sustainability score of the second user based on determining the second user is not associated with the second data;
generate a second plurality of recommendations for the second user based on the base sustainability score of the second user;
identify a response to the second plurality of recommendations; and
adjust the base sustainability score of the second user based on the response.

15. The system of claim 1, wherein the data store is further configured to store further machine-readable instructions that, when executed by the processor, cause the processor to:
determine the sustainability score of the user exceeds a threshold,
wherein generating the plurality of recommendations for the user based on the sustainability score of the user is based on determining the sustainability score of the user exceeds the threshold.

16. The system of claim 1, wherein the data store is further configured to store further machine-readable instructions that, when executed by the processor, cause the processor to:
monitor a dynamic threshold; and
determine the sustainability score of the user exceeds the dynamic threshold,
wherein generating the plurality of recommendations for the user based on the sustainability score of the user is based on determining the sustainability score of the user exceeds the dynamic threshold.

17. The system of claim 1, wherein the data store is further configured to store further machine-readable instructions that, when executed by the processor, cause the processor to:
perform reinforcement learning to dynamically adjust the sustainability score of the user.

18. The system of claim 1, wherein to generate the sustainability score of the user, the machine learning model is further configured to determine a mutability of the user based on a plurality of previous item purchases of the user, wherein the mutability of the user identifies a probability of the user to purchase a different item, wherein the sustainability score of the user is further based on the mutability of the user.

19. The system of claim 1, wherein the account data associated with the user comprises a plurality of recency, frequency, and monetary values associated with a plurality of previous item purchases of the user.

20. The system of claim 19, wherein the data store is further configured to store further machine-readable instructions that, when executed by the processor, cause the processor to:
generate a plurality of recency, frequency, monetary, and sustainability score values of the user based on the sustainability score of the user; and
update the account data associated with the user based on the plurality of recency, frequency, monetary, and sustainability score values.

21. The system of claim 1, wherein identifying the account data associated with the user is based on obtaining a prompt via the user computing device, wherein the prompt comprises a request to purchase a particular item, an indication that the user is browsing the particular item, or a purchase of the particular item.

22. A computer-implemented method comprising:
identifying account data associated with a user, the account data identifying one or more characteristics of the user;
accessing a machine learning model for generating a sustainability score of the user, wherein the sustainability score of the user is indicative of a propensity for conversion to sustainability of the user that identifies a probability of the user to purchase sustainable items, wherein generating the sustainability score of the user comprises:
parsing the account data associated with the user to identify the one or more characteristics of the user, and
generating the sustainability score of the user based on the one or more characteristics of the user;
generating a plurality of recommendations for the user, the plurality of recommendations comprising recommendations to purchase non-sustainable items and at least one sustainable item based on the sustainability score of the user; and
causing display, via a display of a user computing device associated with the user, of the plurality of recommendations.

23. A non-transitory computer-readable medium storing computer-executable instructions that, when executed by a processor, configure the processor to:
identify account data associated with a user, the account data identifying one or more characteristics of the user;
access a machine learning model for generating a sustainability score of the user, wherein the sustainability score of the user is indicative of a propensity for conversion to sustainability of the user that identifies a probability of the user to purchase sustainable items, wherein to generate the sustainability score of the user, the machine learning model is configured to:
parse the account data associated with the user to identify the one or more characteristics of the user, and
generate the sustainability score of the user based on the one or more characteristics of the user;
generate a plurality of recommendations for the user, the plurality of recommendations comprising recommendations to purchase non-sustainable items and at least one sustainable item based on the sustainability score of the user; and
cause display, via a display of a user computing device associated with the user, of the plurality of recommendations.
